(19) United States
(12) Patent Application Publication
(10) Pub. No.: US 2021/0148339 A1
(43) Pub. Date: May 20, 2021

(54) A Cone Shaped Pin for Tower Wall Attachment

(71) Applicant: Envision Energy (Jiangsu) Co., Ltd., Wuxi (CN)

(72) Inventors: Lufei Zhou, Wuxi (CN); Yixu Zhang, Wuxi (CN); Kai Qi, Wuxi (CN); Yuankang Lu, Wuxi (CN); Weiqing Zhang, Wuxi (US)

(21) Appl. No.: 16/616,728

(22) PCT Filed: May 26, 2017
(86) PCT No.: PCT/CN2017/086091

§ 371 Date: Nov. 25, 2019

(51) Int. Cl. F03D 80/80; F16B 19/02; F16B 5/06; F03D 13/20

(52) U.S. Cl. CPC F03D 80/80; F16B 19/02; F05B 2260/301; F03D 13/20; F05B 2240/912; F16B 5/065

(57) ABSTRACT

A cone shaped pin (16) for tower wall attachment is disclosed. The pin comprises a cone (22) with a first head (23) and a second head (24), the first head is larger than the second head. The pin further comprises an internal hole (18a) which is at least accessible from the second head. A system (15) for tower wall attachment and a method for mounting the system are also disclosed. In the case of using the system comprising the pin, tower wall attachment is better and safer than that in the art, and welding is avoid, thus greatly simplifies the process of fixing and improves the performance of the tower.

### FIELD OF THE INVENTION

The present invention relates to a cone shaped pin for tower wall attachment, a system for wall attachment comprising a cone shaped pin, a method for mounting the system and the use of a system.

### BACKGROUND OF THE INVENTION

In the tower of a wind turbine, a lot of internal accessories are fixed to the wall of the tower. The fixing method of internal accessories does not only directly determine the safety of personal and reliability of the product but also has a great influence on the maintenance and the cost.

The tower plays an important role in the wind turbine; it does not only act as a connecting link but also carries the weight of the whole wind turbine. At the same time, a lot of internal accessories are installed in the tower to ensure the normal operation of the wind turbine. At present, most of the accessories are fixed on the tower by welding. However, fixing accessories by welding has some problems. The welding in the tower can cause fatigue and hence, reduce the strength of the tower so that the thickness of the tower wall has to increase to ensure sufficient strength. The increase of the wall thickness leads to a large increase in the cost which greatly reduces the competitiveness of the wind turbine.

Thus, the fixing method of internal accessories is very important.

### OBJECT OF THE INVENTION

The object of this invention is to provide a new fixing method, a tower wall attachment, of the type mentioned in the introduction, which is better and safer than prior-art technology.

It is a further object of the invention to provide a tower wall attachment where there is no welding and which greatly simplifies the process of fixing and improves the performance of the tower, without leading to an increase in the cost of the tower.

### DESCRIPTION OF THE INVENTION

According to a first aspect of the invention, the above object is achieved with a cone shaped pin for tower wall attachment of the type mentioned in the introduction, where the cone shaped pin comprises a cone with a first head and a second head, where the first head is larger than the second head and where the cone shaped pin further comprises an internal hole, where the hole at least is accessible from the second head.

This makes it possible to embed a cone shaped pin into a corresponding hole in a tower wall, where the large head of the cone shaped pin is positioned at the outside of the wall and the smaller head is positioned towards the inside. So a force with the direction from outside to inside can firmly fix the cone shaped pin in the wall.

The cone shaped pin is embedded into the wall of the tower to connect internal accessories and the wall.

The first head might be convex in order to avoid sharp edges. The hole might as well be a through hole in case sensors, cables, etc. have to get through or at least get access to the other side of the wall. The hole could for example also be intended for an expander.

When having a drilled hole in the tower the alternative to using a cone shaped pin is a bolt, but it has the following drawbacks:
A bolt needs to be tightened with intervals,
A bolt needs to be sealed off for water intrusion,
Problems with surface treatment of the tower.

In a second aspect, the present invention also relates to a cone shaped pin, where the internal hole comprises a thread.

This makes it possible to use the thread to fix internal accessories in combination with a bolt.

In a third aspect, the present invention also relates to a cone shaped pin, where the cone comprises a gradient of 1:5-1:20, preferably 1:10. In a fourth aspect, the present invention also relates to a cone shaped pin, where the first head comprises an external diameter of ϕ20 mm-ϕ30 mm, preferably ϕ26 mm. In a fifth aspect, the present invention also relates to a cone shaped pin, where the internal thread is M10-M20, preferably M12. In a sixth aspect, the present invention also relates to a cone shaped pin, where the material of the cone is stainless steel.

This makes it possible, with a preferred gradient; a preferred external diameter; a preferred size of thread and material, to ensure an optimal functionality and at the same time make a force possible with the direction acting from the largest diameter towards the smallest diameter and hence, from the outside towards the inside of the tower wall to firmly fix the cone shaped pin to and in the wall.

In a seventh aspect, the present invention also relates to a system for wall attachment comprising a cone shaped pin, where the system further comprises at least a bolt and a sleeve with a through hole, where the bolt through the sleeve is connected to the cone shaped pin for fastening a bracket for the tower internals, such as ladders, cables, platforms, etc.

This makes it possible to connect internal accessories and the wall, where the bolt and the sleeve, together with the cone shaped pin, can be used to fix the internal accessories on the tower wall. It simplifies the process of fixing and improves the performance of the tower. With this system no welding is needed, hence, no fatigue or reduction of the strength of the tower occurs.

A bracket is in this aspect equal to any part being a separate part or an integral part of the internal accessory, like ladders, bearings or the like and which is used for fastening such internal accessories.

The reason for having the sleeve is that the internal accessories often cannot be fixed if connected with the cone directly without an adaption of the internal accessories to the curvature of the tower wall. Thus, the invention often cannot work without the sleeve. The sleeve may be used as a form of adapter.

In an eight aspect, the present invention also relates to a method for mounting the system in a tower wall, where the method at least comprises the following steps:
Drilling a hole and machining allowance of one side
Bearizing using a mould milling cutter
Reaming using a reamer
Insert the second head of the cone shaped pin in the largest side of the hole
Connect a bolt through a sleeve to the thread in the cone shaped pin from the other side of the hole.

This makes it possible to connect internal accessories and the wall by using the system and the method for mounting the system in a tower wall.

In a ninth aspect, the present invention also relates to a use of a system for tower wall attachment, where the tower is a wind turbine tower.

### DESCRIPTION OF THE DRAWING

The invention will be described in further detail below by means of non-limiting embodiments with reference to the drawing, in which:

FIG. 1 shows an exemplary embodiment of a wind turbine;

FIG. 2 shows an exemplary embodiment of a wall attachment used inside a tower;

FIG. 3 shows an exemplary embodiment of the system for wall attachment, comprising a cone shaped pin;

In the drawings, the following reference numerals have been used for the designations used in the detailed part of the description:
1 Wind turbine
2 Ground level
3 Foundation
4 Wind turbine tower
5 Nacelle
6 Rotor hub
7 Wind turbine blades
8 Tip end
9 Blade root
10 Inside, tower
11 Tower wall attachment
12 Bracket/Internal accessory
13 Ladder
14 Pipe-/cable bearing
15 System
16 Cone shaped pin
17 Tower wall
18a Internal hole
18b thread
19 Bolt
20 Sleeve
21 Cone shaped hole
22 Cone
23 First head
24 Second head
25 Through hole

### DETAILED DESCRIPTION OF THE INVENTION

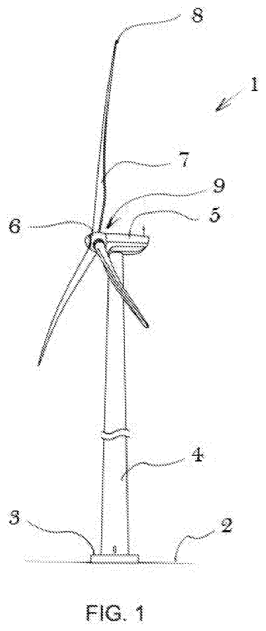

FIG. 1 shows an exemplary embodiment of a wind turbine 1 arranged relative to a ground level 2. The wind turbine 1 comprises a wind turbine tower 4 having a top end and a bottom end facing away from the top end. The bottom end is configured for mounting to a mounting end of a foundation 3. The wind turbine tower 4 may comprise two, three or more tower sections (not shown) that are mounted together to form the wind turbine tower 4. A nacelle 5 is arranged at the top of the wind turbine tower 4 and is rotatable connected to the wind turbine tower 4, e.g. via a yaw mechanism (not shown). A rotor having a rotor hub 6 is rotatable connected to the nacelle 5, e.g. via a bearing assembly between the rotor hub 6 and the main frame structure of the nacelle 5. Two or more wind turbine blades 7 (three wind turbine blades are shown), are connected to the rotor hub 6, e.g. via one or more pitch mechanisms (not shown). The wind turbine blades 7 extend outwards from the centre of the rotor hub 6 to form a plane of rotation where each blade 7 comprises a tip end 8 and a blade root 9.

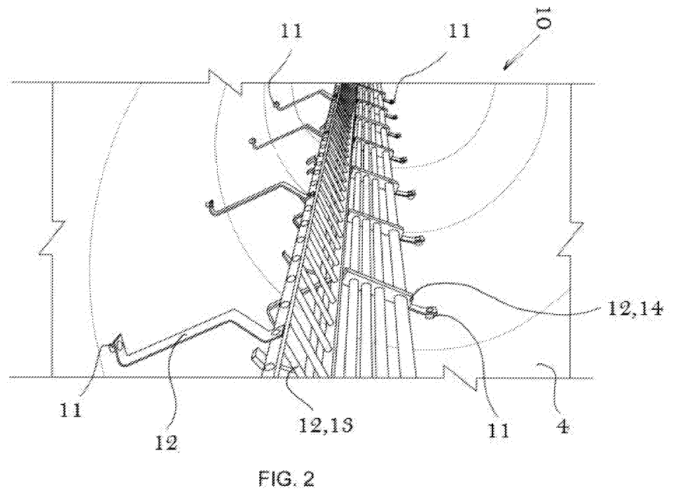

FIG. 2 shows an exemplary embodiment of a wall attachment 11 used at the inside 10 of a tower 4, to fasten a bracket 12 for various internal accessories, here shown as a ladder 13 and pipe-/cable bearings 14 to the tower 4.

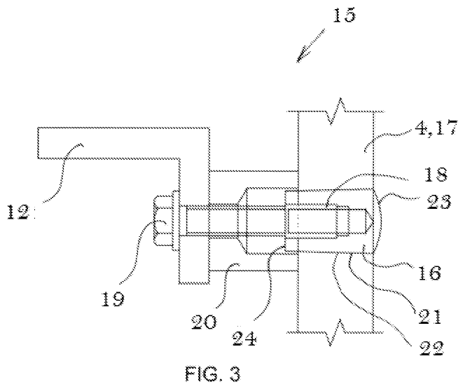

FIG. 3 shows an exemplary embodiment of a system 15 for wall attachment and the principle of fixing internal accessories 12, 13, 14 by means of a cone shaped pin 16. The cone shaped pin 16 is embedded in the tower wall 17 and the shown cone shaped pin 16 has an internal hole 18a and a thread 18b in the core. The shown bolt 19 and sleeve 20 are then used to fix the internal accessories/bracket 12 on the tower wall 17.

Firstly, a cone shaped hole 21 is processed in the tower wall 17. Then a corresponding cone shaped pin 16 is embedded into the cone shaped hole 21 in the tower wall 17.

The first head 23 is larger than the second head 24 and the first head 23 of the cone shaped pin 16 is in the direction of the outside of the tower wall 17 and the second head 24 is in the direction of the inside 10 of the tower 4. So a force with the direction from the outside to the inside can firmly fix the cone shaped pin 16 to the tower wall 17. The internal hole 18a and the thread 18b in the core of the cone shaped pin 16 combined with bolts 19 and sleeves 20 can firmly fix internal accessories/bracket 12 to the tower wall 17 without any welding.

The cone shaped pin 16 comprises a cone 22 with a first head 23 and a second head 24, where the first head 23 is larger than the second head 24 and where the cone shaped pin 16 further comprises an internal hole 18a, where the hole 18a is at least accessible from the second head 24. The cone shaped pin 16 has an internal hole 18a comprising a thread 18b; where the cone 22 comprises a gradient of 1:5-1:20, preferably 1:10; where the first head 23 comprises an external diameter of ϕ20 mm-ϕ30 mm, preferably ϕ26 mm; the thread 18b is M10-M20, preferably M12 and where the material of the cone is stainless steel.

The system 15 further comprises at least a bolt 19 and a sleeve 20 with a through hole 25, where the bolt 19 through the sleeve 20 is connected to the cone shaped pin 16 for fastening a bracket 12 for the tower internals, such as ladders, cables, platforms etc.

1. A cone shaped pin for tower wall attachment, wherein the cone shaped pin comprises a cone with a first head and a second head, where the first head is larger than the second head and where the cone shaped pin further comprises an internal hole, where the hole at least is accessible from the second head.

2. A cone shaped pin according to claim 1, wherein the internal hole comprises a thread.

3. A cone shaped pin according to claim 1, wherein the cone comprises a gradient of 1:5-1:20, preferably 1:10.

4. A cone shaped pin according to claim 1, wherein the first head comprises an external diameter of Φ20 mm-Φ30 mm, preferably Φ26 mm.

5. A cone shaped pin according to claim 1, wherein the internal thread is M10-M20, preferably M12.

6. A cone shaped pin according to claim 1, wherein the material of the cone is stainless steel.

7. System for wall attachment comprising a cone shaped pin according to claim 1, wherein the system further comprises at least a bolt and a sleeve with a through hole, where the bolt through the sleeve is connected to the cone shaped pin for fastening a bracket for the tower internals, such as ladders, cables, platforms, etc.

8. Method for mounting the system according to claim 7 in a tower wall, wherein the method at least comprises the following steps:
Drilling a hole and machining allowance of one side
Bearizing using a mould milling cutter
Reaming using a reamer
Inserting the second head of the cone shaped pin in the largest side of the hole
Connecting a bolt through a sleeve to the thread in the cone shaped pin from the other side of the hole.

9. Use of a system according to claim 7 for tower wall attachment, wherein the tower is a wind turbine tower.
